(19) United States
(12) Patent Application Publication
(10) Pub. No.: US 2026/0025174 A1
(43) Pub. Date: Jan. 22, 2026

(54) APPARATUS AND METHOD FOR CHANNEL SOUNDING

(71) Applicant: Samsung Electronics Co., Ltd., Suwon-si (KR)

(72) Inventor: Eunsung Jeon, Suwon-si (KR)

(21) Appl. No.: 19/261,436

(22) Filed: Jul. 7, 2025

(30) Foreign Application Priority Data
Jul. 16, 2024 (KR) 10-2024-0094013
Oct. 15, 2024 (KR) 10-2024-0140603

(51) Int. Cl. H04B 7/06; H04B 17/309; H04L 25/02; H04W 84/12

(52) U.S. Cl. CPC H04B 7/0617; H04B 17/346; H04L 25/0204; H04W 84/12

(57) ABSTRACT

Provided is a method of operating a first device that communicates with a second device in a wireless local area network (WLAN) system including the first device and the second device, the method including receiving a null data packet (NDP) from the second device, generating a plurality of channel information corresponding to a plurality of respective subcarriers by using the NDP, performing pre-processing on the plurality of channel information based on a pre-processing function designed to have a plurality of variable sections, performing encoding on the plurality of pre-processed channel information to result in a plurality of encoded channel information, and transmitting a beamforming feedback including the plurality of encoded channel information to the second device.

### CROSS-REFERENCE TO RELATED APPLICATIONS

This application is based on and claims priority under 35 U.S.C. § 119 to Korean Patent Application Nos. 10-2024-0094013, filed on Jul. 16, 2024 and, 10-2024-0140603, filed on Oct. 15, 2024 in the Korean Intellectual Property Office, the disclosures of which are incorporated by reference herein in their entirety.

### BACKGROUND

The inventive concept relates to wireless communication, and more particularly, to an apparatus and method for channel sounding based on a certain protocol standard.

As an example of wireless communication, a wireless local area network (WLAN) is a technology for interconnecting two or more devices by using a wireless signal transmission scheme. The WLAN may be based on the Institute of Electrical and Electronics Engineers (IEEE) 802.11 standard. The 802.11 standard has been developed according to standards like 802.11b, 802.11a, 802.11g, 802.11n, 802.11ac, and 802.11ax and may support transmission speeds up to 1 Gbyte/s based on the orthogonal frequency-division multiplexing (OFDM) technique.

In the 802.11ac standard, data may be simultaneously transmitted to a plurality of users by using multi-user multi-input multi-output (MU-MIMO) scheme. Meanwhile, the next-generation protocol standard after 802.11be, extremely high throughput (EHT) (hereinafter referred to as EHT+) aims to support the 6GHz unlicensed frequency band, utilize a bandwidth of up to 320 MHz per channel, introduce hybrid automatic repeat and request (HARQ), and support up to 16×16 MIMO.

Also, in a single user (SU)-MIMO communication environment or a MU-MIMO communication environment, a beamforming process may be used to improve communication performance. In detail, a beamformer (or an access point) performing a beamforming process may perform beamforming based on beamforming feedback regarding a channel received from a beamformee (or a station). For efficient beamforming feedback transmission and reception between a beamformee and a beamformer, a technology has been studied to encode and compress a plurality of channel information by using an encoder trained based on an autoencoder or to decode and decompress the plurality of channel information by using a decoder trained based on an autoencoder.

### SUMMARY

Aspects of the inventive concept provide a device and method for supporting pre- processing and post-processing operations for improving the performance of an encoder and a decoder according to training when the encoder and the decoder based on an autoencoder are trained in a wireless communication system.

According to an aspect of the inventive concept, an operating method of a first device that communicates with a second device in a wireless local area network (WLAN) system including the first device and the second device is disclosed. The operating method includes receiving a null data packet (NDP) from the second device; generating a plurality of channel information corresponding to a plurality of respective subcarriers by using the NDP; performing pre-processing on the plurality of channel information based on a pre-processing function designed to have a plurality of variable sections to result in a plurality of pre-processed channel information; performing encoding on the plurality of pre-processed channel information to result in a plurality of encoded channel information; and transmitting beamforming feedback comprising the plurality of encoded channel information to the second device.

According to another aspect of the inventive concept, a method of operating a second device that communicates with a first device in a WLAN system including the first device and the second device is disclosed. The method includes receiving a beamforming feedback from the first device, extracting a plurality of channel information corresponding to a plurality of subcarriers from the beamforming feedback, performing decoding on a plurality of extracted channel information, performing post-processing on a plurality of decoded channel information based on a post-processing function, which is an inverse function of a pre-processing function designed to have a plurality of variable sections used for pre-processing of the first device, and performing beamforming based on a plurality of post-processed channel information.

According to another aspect of the inventive concept, a first device communicates with a second device in a WLAN system. The first device includes a channel estimator configured to estimate channels corresponding to a plurality of subcarriers by using an NDP received from the second device, and a beamforming feedback generator configured to generate a plurality of channel information corresponding to a plurality of subcarriers based on estimated channels, perform pre-processing on the plurality of channel information based on a pre-processing function designed to have a plurality of variable sections, perform encoding on a plurality of pre-processed channel information, and generate a beamforming feedback including a plurality of encoded channel information.

### BRIEF DESCRIPTION OF THE DRAWINGS

Embodiments of the inventive concept will be more clearly understood from the following detailed description taken in conjunction with the accompanying drawings in which:

FIG. 1 is a block diagram showing a wireless communication system according to an embodiment;

FIG. 2A is a block diagram showing a wireless communication system according to an embodiment, and FIG. 2B is a diagram showing an autoencoder according to an embodiment;

FIG. 3 is a timing diagram illustrating channel sounding according to an embodiment;

FIG. 4 is a message diagram illustrating a method for channel sounding according to an embodiment;

FIG. 5 is a message diagram illustrating a method for channel sounding according to an embodiment;

FIG. 6 is a detailed block diagram showing a beamformee according to an embodiment;

FIG. 7A is a diagram for describing the operation of the pre-processing circuit of FIG. 6, and FIG. 7B is a diagram for describing an implementation example of the encoder of FIG. 6;

FIG. 8 is a detailed block diagram showing a beamformer according to an embodiment;

FIG. 9 is a flowchart for describing the operation of a beamformee according to an embodiment;

FIG. 10 is a flowchart for describing the operation of a beamformer according to an embodiment;

FIGS. 11A to 11C are diagrams illustrating a pre-processing function, which is the basis for a pre-processing operation according to an embodiment;

FIG. 12 is a message diagram illustrating a method of determining a pre-processing function or a post-processing function, according to an embodiment;

FIG. 13 is a message diagram illustrating a method of processing beamforming feedback, according to an embodiment;

FIG. 14 is a block diagram of an electronic device according to an embodiment; and

FIG. 15 is a conceptual diagram showing an Internet of Things (IoT) network system to which embodiments are applied.

### DETAILED DESCRIPTION OF THE EMBODIMENTS

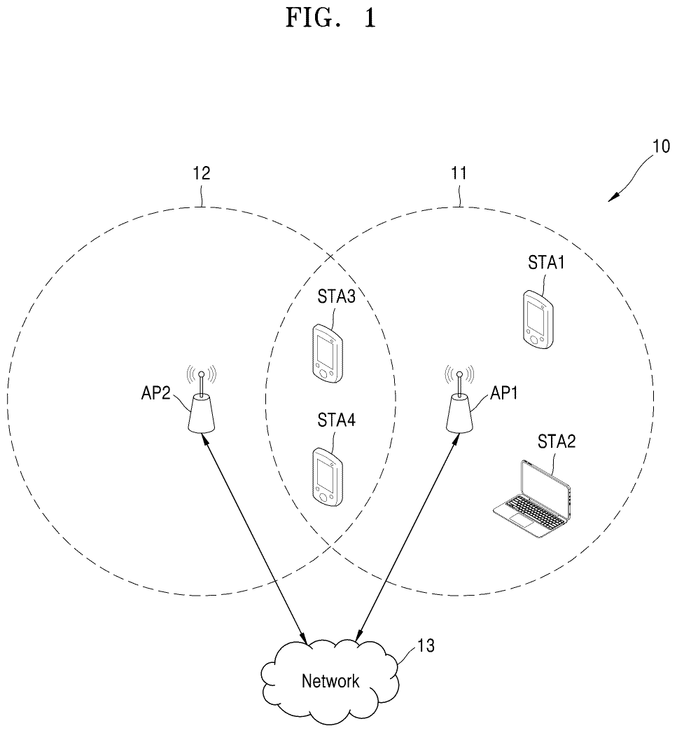

FIG. 1 is a block diagram showing a wireless communication system 10 according to an embodiment. In detail, FIG. 1 shows a wireless local area network (WLAN) system as an example of the wireless communication system 10.

Hereinafter, embodiments of the inventive concept will be described in detail mainly based on an OFDM or OFDMA-based wireless communication system (particularly, the IEEE 802.11 standard). However, the inventive concept may also be applied to any other communication systems having a similar technical background and a channel structure, e.g., a cellular communication system like long term evolution (LTE), LTE-advance (LTE-A), new radio (NR), wireless broadband (WiBro), and global system for mobile communication (GSM) or a short-distance communication system like Bluetooth and near field communication (NFC) with modifications within a range not significantly deviating from the scope of the inventive concept, based on a decision of one of ordinary skill in the art.

In various embodiments described below, a hardware approach is described as an example. However, since various embodiments include technology using both hardware and software, the various embodiments do not exclude a software-based approach. For example, various functions can be carried out using hardware or using hardware combined with software and/or firmware, for example, using one or more processors, controllers, memory devices, communications components, etc.

Also, it will be fully understood that the terms used in the following descriptions are merely examples for convenience of explanation and that the technical ideas of the inventive concept are not limited thereto.

Referring to FIG. 1, the wireless communication system 10 may include a first access point AP1, a second access point AP2, a first station STA1, a second station STA2, a third station STA3, and a fourth station STA4. The first access point API and the second access point AP2 may access a network 13 such as the Internet, an Internet protocol (IP) network, or any other network. The first access point AP1 may provide access to the network 13 within a first coverage region 11 to the first station STA1, the second station STA2, the third station STA3, and the fourth station STA4 (e.g., when they are in the first coverage region 11), and the second access point AP2 may also provide access to the network 13 within a second coverage region 12 to the third station STA3 and the fourth station STA4 (e.g., when they are in the second coverage region 12). In some embodiments, the first access point AP1 and the second access point AP2 may communicate with at least one of the first station STA1, the second station STA2, the third station STA3, and the fourth station STA4, and may communicate with each other, based on the wireless fidelity (WiFi) or any other WLAN access technology.

An access point may be a router or a gateway, and a station may be a mobile station, a subscriber station, a terminal, a mobile terminal, a wireless terminal, a user equipment, and a user (e.g., provided the user possesses a device configured to implement the various embodiments described herein). A station may be a portable device such as a mobile phone, a laptop computer, or a wearable device or may be a stationary device such as a desktop computer or a smart TV. In this specification, a station may be referred to as a first device, and an access point may be referred to as a second device. However, the terms “first” and “second” unless indicated otherwise, are only used as a naming convention.

The first access point AP1 and the second access point AP2 may allocate at least one resource unit (RU) to at least one of first to fourth stations STA1 to STA4. The first access point AP1 and the second access point AP2 may transmit data through at least one allocated RU, and the at least one station may receive data through the at least one allocated RU. In 802.11ax, the first access point AP1 and the second access point AP2 may allocate only a single RU to each station and each RU can only be used by one station at a time. However, in 802.11be (hereinafter referred to as EHT) or next-generation IEEE 802.11 standards (hereinafter, referred to as EHT+), the first access point AP1 and the second access point AP2 may allocate a multiple resource unit (MRU) including two or more RUs to each station. For example, the first access point AP1 may allocate an MRU to at least one of the first station STA1, the second station STA2, the third station STA3, and the fourth station STA4 and may transmit data through the allocated MRU.

The first access point AP1 and the second access point AP2 may communicate with at least one of stations STA1 to STA4 by using the beamforming technique. For example, single-user beamforming may improve reception performance of a single user, and multi-user beamforming may improve reception performance of multiple users overall by eliminating interference between the multiple users. The first access point AP1 and the second access point AP2 and the stations STA1 to STA4 may perform channel sounding for beamforming, and the channel sounding may be based on a sounding protocol. As described below with reference to the drawings, the first access point AP1 and the second access point AP2 may efficiently perform channel sounding with the stations STA1 to STA4 supporting various protocol standards (e.g., EHT, EHT+, etc.). Hereinafter, a schematic embodiment of channel sounding between the first access point AP1 and the first station STA1 is described. The technical idea of channel sounding between the first access point AP1 and the first station STA1 may also be applied to the second access point AP2 and second to fourth stations STA2 to STA4.

According to an embodiment, the first access point API may transmit a null data packet (NDP) based on a certain protocol standard to the first station STA1. The first station STA1 may generate information regarding channels formed between the first access point AP1 and the first station STA1 using the NDP.

Below, a series of operations of the first station STA1 for transmitting beamforming feedback to the first access point AP1 are described.

According to an embodiment, the first station STA1 may generate information regarding a plurality of channels corresponding to a plurality of subcarriers using the received NDP. The plurality of subcarriers may correspond to subcarriers that the first access point AP1 wants the first station STA1 to provide channel-related feedback to, and information indicating the plurality of subcarriers may be provided in advance from the first access point AP1 to the first station STA1. In detail, for example, the first station STA1 may generate a plurality of respective beam steering matrices corresponding to a plurality of respective subcarriers by singular value decomposition of estimated channels, generate a plurality of respective sets of angle information respectively corresponding to the plurality of subcarriers from the beam steering matrices, and quantize each of the plurality of sets of generated angle information into a bit size corresponding to a codebook size. For example, a codebook size is determined by the first access point AP1, and information indicating the corresponding codebook size may be provided from the first access point AP1. Also, as a specific example, the first station STA1 may generate signal to noise ratios (SNRs) respectively corresponding to the plurality of subcarriers using a received NDP, generate a plurality of sets of delta-SNR information respectively corresponding to the plurality of subcarriers based on generated SNRs, and quantize each of the plurality of sets of generated delta-SNR information into a certain bit size. For example, the certain bit size may be agreed upon in advance between the first access point API and the first station STA1 by a certain protocol standard. As used herein, the expression “a plurality of . . . information” refers to a plurality of sets of information, wherein each set of information includes information about one of the items being discussed. For example, a plurality of channel information refers to a plurality of sets of information, each set of information corresponding to a respective channel of a plurality of channels.

In this specification, the plurality of channel information (e.g., plurality of sets of channel information) may include the plurality of quantized angle information (e.g., plurality of sets of quantized angle information) or the plurality of quantized delta-SNR information (e.g., plurality of sets of quantized delta-SNR information, as described above. However, this is merely an example embodiment, and the inventive concept is not limited thereto. Various channel-related information defined to be included in beamforming feedback may also be included in the plurality of channel information to be pre-processed.

According to an embodiment, the first station STAI may perform pre-processing on a plurality of channel information based on a pre-processing function. In this specification, pre-processing for a plurality of channel information may be performed before the plurality of channel information is input to an encoder as training data for training an autoencoder-based encoder or before the plurality of channel information is input to an autoencoder-based trained encoder. In this specification, an autoencoder may be defined as a neural network architecture designed to efficiently encode (or compress) input data based on the main features of the input data and then decode (or decompress) encoded data back to original data. A pre-processing circuit used for pre-processing a plurality of channel information in the first station STA1 may be designed to suit the encoder, such that the training performance of the encoder or the performance of the trained encoder may be improved. For example, a pre-processing function used by a pre-processing circuit may be designed to match the characteristics of a plurality of sets of channel information. For example, the pre-processing function may be a one-to-one correspondence function, a continuous function, and designed to satisfy a condition in which a difference between a first function output according to the minimum input and a second function output according to the maximum input is less than a threshold value (e.g., a condition in which the first function output and the second function output are identical or similar to each other). As a result, the pre-processing function may have a plurality of variable sections and be defined as a different function for each variable section. Therefore, the first station STAI may perform pre-processing on a plurality of channel information based on a pre-processing function to generate a plurality of pre-processed channel information and binary information corresponding to the plurality of pre-processed channel information. In this specification, binary information may be information indicating a variable section to which pre-processed channel information belongs from among a plurality of variable sections of a pre-processing function, and may be used for post-processing. Also, the number of bits included in the binary information may correspond to the number of variable sections of a pre-processing function.

According to an embodiment, the first station STA1 may perform encoding on a plurality of pre-processed channel information. For example, the first station STA1 may encode a plurality of pre-processed channel information by using an autoencoder-based encoder.

According to an embodiment, the first station STA1 may generate beamforming feedback including a plurality of encoded channel information and transmit the beamforming feedback to the first access point AP1. For example, the beamforming feedback may further include the above-stated binary information together with the plurality of encoded channel information.

Hereinafter, a series of operations of the first access point AP1 to perform beamforming based on beamforming feedback are described.

According to an embodiment, the first access point AP1 may receive beamforming feedback from the first station STA1.

According to an embodiment, the first access point AP1 may extract a plurality of channel information corresponding to a plurality of subcarriers from the beamforming feedback. As described above, the plurality of channel information included in the beamforming feedback may be encoded at the first station STA1.

According to an embodiment, the first access point AP1 may perform decoding on the plurality of extracted channel information. For example, the first access point API may decode the plurality of extracted channel information by using an autoencoder-based decoder.

According to an embodiment, the first access point AP1 may perform post-processing on the plurality of decoded channel information based on a post-processing function. In this specification, post-processing on a plurality of channel information may be performed before a plurality of decoded channel information output from a decoder is compared with original data for training an autoencoder-based decoder or before a plurality of decoded channel information output from a trained autoencoder-based decoder is used for beamforming. A post-processing circuit used for post-processing a plurality of channel information in the first access point API may be designed and configured to match the pre-processing circuit. For example, the post-processing function used by the post-processing circuit may be an inverse function of the pre-processing function used at the first station STA1. According to an embodiment, the first access point AP1 may further extract binary information corresponding to a plurality of channel information from beamforming feedback (e.g. from a beamforming feedback signal or beamforming feedback signals) and perform post-processing on a plurality of decoded channel information based on a post-processing function and extracted binary information.

According to an embodiment, the first access point API may perform beamforming based on a plurality of post-processed channel information. In detail, the first access point AP1 may perform beamforming suitable for the first station STA1 based on the plurality of post-processed channel information and transmit a physical protocol data unit (PPDU) to the first station STA1.

Embodiments of transmitting and receiving beamforming feedback from the first access point AP1 and the first station STA1 and performing beamforming based on the beamforming feedback may be defined by a certain protocol standard. For example, the certain protocol standard may be an EHT protocol standard or an EHT+ protocol standard.

The stations STA1 to STA4 and the access points AP1 and AP2 according to embodiments may efficiently transmit and receive beamforming feedback by supporting pre-processing operations and post-processing operations to improve the performance of an autoencoder, thereby improving overall communication performance.

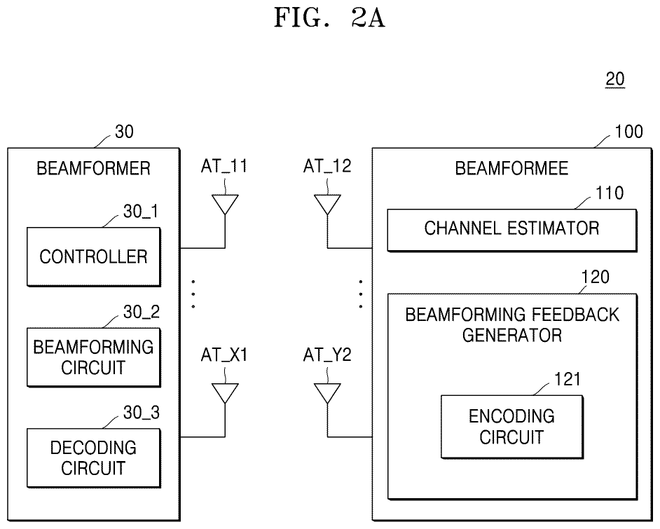

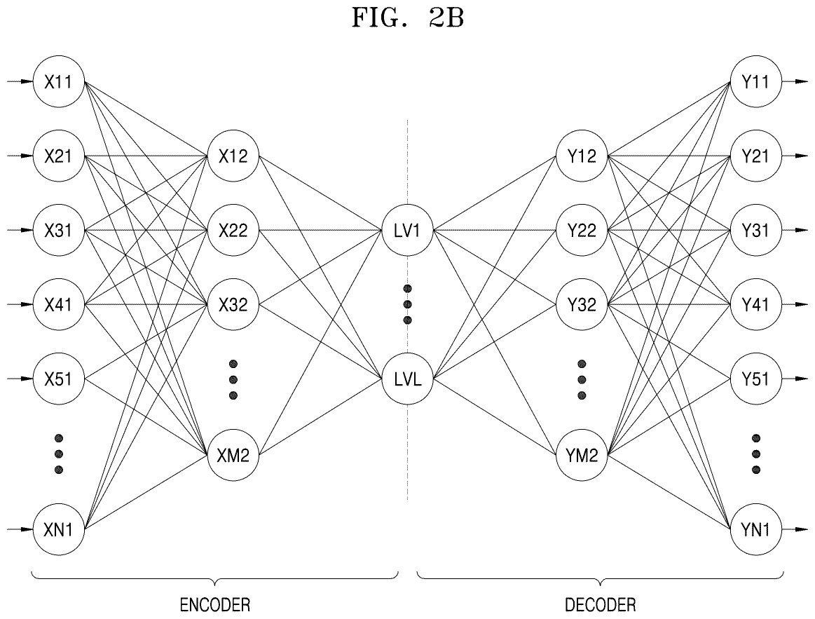

FIG. 2A is a block diagram showing a wireless communication system 20 according to an embodiment, and FIG. 2B is a diagram showing an autoencoder according to an embodiment. FIG. 2A shows a beamformer 30 and a beamformee 100 communicating with each other within the wireless communication system 20. The beamformer 30 and the beamformee 100 may each be any device that communicates in the wireless communication system 20 and may be referred to as a device for wireless communication. According to some embodiments, the beamformer 30 and the beamformee 100 may each be an access point (or second device) or a station (or first device) of a WLAN system. In one embodiment, the beamformer 30 is an access point and the beamformee 100 is a station.

Referring to FIG. 2A, the beamformer 30 may include a controller 30_1, a beamforming circuit 30_2, a decoding circuit 30_3, and a plurality of first antennas AT_11 to AT_X1. According to some embodiments, the controller 30_1, the beamforming circuit 30_2, and the decoding circuit 30_3 may constitute a processing circuit of the beamformer 30. The beamformee 100 may include a channel estimator 110, a beamforming feedback generator 120, and a plurality of second antennas AT_12 to AT_Y2. According to some embodiments, the channel estimator 110 and the beamforming feedback generator 120 may constitute a processing circuit of the beamformee 100. Below, the beamformee 100 is described first.

The beamformee 100 may receive an NDP from the beamformer 30 through the plurality of second antennas AT_12 to AT_Y2. The channel estimator 110 may estimate channels for a plurality of subcarriers by using a reference signal included in a received NDP. According to some embodiments, an NDP may also be referred to as a sounding packet. An NDP (yₖ) received by the channel estimator 110 for channel estimation may be expressed as shown in [Equation 1].

$${y}_{k} = {H}_{k} {x}_{k} + {n}_{k} \qquad [ Equation l ]$$

In [Equation 1], Hₖ may indicate a channel matrix of a subcarrier, xₖ may indicated a transmission data signal, and nₖ may indicate a thermal noise. k may represent the subcarrier index of a channel and may have a range from 1 to NFFT. A channel matrix (Hₖ) may have the size of Nr×Nt. Here, Nr may be an index related to the number of the second antennas AT_12 to AT_Y2, and Nt may be an index related to the number of the first antennas AT_11 to AT_X1. The number of streams per subcarrier may be determined by Nr and Nt. Each element of [Equation 1] may be defined as a matrix or a vector. For example, a transmission data signal xₖ may have the size of Nt×1. Thermal noise nₖ may mean white Gaussian noise. The thermal noise nₖ may have the size of Nr×1.

The channel estimator 110 may generate channel state information based on an estimated channel. The channel state information may include at least one of a channel quality indicator (CQI), a precoding matrix indicator (PMI), and a rank indicator (RI).

The beamforming feedback generator 120 may perform singular value deposition on channels Ĥ_{est,k} estimated by the channel estimator 110 as shown in [Equation 2].

$${\hat{H}}_{est , k} = {U}_{k} {\sum }_{k} {V}_{k}^{h} \qquad [ Equation 2 ]$$

In [Equation 2], Uₖ is a left singular matrix, and Vₖ is a right singular matrix, which may include Hermitian operators. Σₖ may be a diagonal matrix including non-negative singular values.

The left singular matrix Uₖ may have the size of Nr×Nc. Here, Nc may be an index related to the number of streams (or the number of layers) or the number of the first antennas AT_11 to AT_X1. The right singular matrix Vₖ may have the size of Nr×Nc. Also, Σₖ may have the size of Nc×Nc. The right singular matrix Vₖ may be referred to as a beam steering matrix. In the wireless communication system 20 according to some embodiments (e.g., an IEEE 802.11n/ac/ax WLAN system), the beamformer 30 transmits a signal to the beamformee 100 through Orthogonal Frequency Division Multiplexing (OFDM) modulation in which NFFT subcarriers within one symbol are guaranteed to be orthogonal to each other, and thus the channel estimation operation of the channel estimator 110 and the singular value decomposition operation of the beamforming feedback generator 120 may be performed for each subcarrier.

To reduce the feedback overhead transmitted to the beamformer 30, the beamforming feedback generator 120 may apply the diagonal matrix D for perforing a common phase shift to the beam steering matrix Vₖ as shown in [Equation 3] instead of transmitting a beam steering matrix Vₖ to the beamformer 30 as-is.

$${Q}_{k} = {V}_{k} D \qquad [ Equation 3 ]$$

Qₖ is the late beam steering matrix, and a first diagonal matrix D may be a matrix for elements of the last row of each column of the late beam steering matrix Qₖ to have real number values. For example, the first diagonal matrix D may be (e^{-jϕ}_{(Nt,1)}, . . . , e^{-jϕ}_{(Nt,Nr)}. For example, e^{-jϕ}_{(Nt,1)} may indicate the phase value of an element corresponding to a Nt-th row and a first column of the beam steering matrix Vₖ. According to some embodiments, the first diagonal matrix D may include the phase value of the element in the last row of each column of the beam steering matrix Vₖ.

$${Q}_{k} = [ {\prod }_{i = 1}^{min ( {N}_{r} , {N}_{t} - 1 )} [ {D}_{i} ( {1}_{i - 1} , {e}^{j ϕ i , i} , … , {e}^{j {ϕ}_{N r - 1 , i}} , 1 ) {\prod }_{l = i + 1}^{{N}_{t}} {G}_{l i}^{T} ( {ψ}_{l i} ) ] ] {\check{I}}_{Nt \times Nr} \qquad [ Equation 4 ]$$

In [Equation 4], 1ᵢ₋₁ is a vector of 1 with the length of i−1. I_{Nt×Nr} is an identity matrix having the size of Nt×Nr.

In [Equation 4], Dᵢ(1ᵢ₋₁, e^{jϕi,i}, . . . , e^{jϕN}ᵣ₋₁^{,i}, 1) may be expressed as a second diagonal matrix as in [Equation 5] below.

$${D}_{i} ( {1}_{i - 1} , {e}^{j ϕ i , i} , … , {e}^{j {ϕ}_{N r - 1 , i}} , 1 ) = [ \begin{matrix}{I}_{i - 1} & 0 & … & … & 0 \\ 0 & {e}^{j {ϕ}_{i , i}} & 0 & ⋯ & 0 \\ ⋮ & 0 & ⋱ & 0 & 0 \\ ⋮ & ⋮ & 0 & {e}^{j {ϕ}_{{N}_{t - 1 {,}^{i}}}} & 0 \\ 0 & 0 & 0 & 0 & 1\end{matrix} ] , \qquad [ Equation 5 ]$$

In [Equation 4], Gₗᵢ(ψ) is a givens rotation matrix, which may be expressed as in [Equation 6] below.

$${G}_{li} ( ψ ) = [ \begin{matrix}{I}_{i - 1} & 0 & 0 & … & 0 \\ 0 & cos ( ψ ) & 0 & sin ( ψ ) & 0 \\ 0 & 0 & {I}_{l - i - 1} & 0 & 0 \\ 0 & - sin ( ψ ) & 0 & cos ( ψ ) & 0 \\ 0 & 0 & 0 & 0 & {I}_{Nt - 1}\end{matrix} ] \qquad [ Equation 6 ]$$

The beamforming feedback generator 120 may generate angle information, ψ, ϕ indicating phases and sizes from the beam steering matrices Vₖ of a plurality of subcarriers based on [Equation 3] to [Equation 6]. ψ may indicate the size of a beam steering matrix Vₖ, and ϕ may indicate the phase of the beam steering matrix Vₖ.

The beamforming feedback generator 120 may quantize the angle information ψ, ϕ according to [Table 1] below.

TABLE 1

| | |
|---|---|
| SU | MU |

| | Coarse | Fine | Coarse | Fine |
|---|---|---|---|---|
| {b_{ψ}, b_{ϕ}} | Codebook | Codebook | Codebook | Codebook |
| 11ac/ax/be | {2, 4} | {4, 6} | {5, 7} | {7, 9} |

The beamforming feedback generator 120 may quantize the angle information, ψ, ϕ based on a codebook {b_{ψ}, b_{ϕ}}. b_{ψ} may denote a bit size for quantizing ψ, and b_{ϕ} may denote a bit size for quantizing ϕ. For example, when b_{ψ} is 2, ψ may be quantized into 2 bits. According to a current protocol standard, the beamformee 100 may be provided a codebook {b_{ψ}, b_{ϕ}} from the beamformer 30.

In a SU-MIMO communication environment, the beamforming feedback generator 120 may quantize angle information ψ, ϕ based on a coarse codebook {2, 4} or a fine codebook {4, 6}. Also, in a MU-MIMO communication environment, the beamforming feedback generator 120 may quantize angle information ψ, ϕ based on a coarse codebook {5, 7} or a fine codebook {7, 9}.

Quantized angle information may be expressed as in [Equation 7] below.

$${\hat{ψ}}_{i}^{( k )} = \frac{n π}{{2}^{{b}_{ψ} - 1}} + \frac{π}{{2}^{{b}_{ψ}}} , n = 1 , 2 , … , {2}^{{b}_{ψ} - 1} \qquad [ Equation 7 ]$$

$${\hat{ϕ}}_{i}^{( k )} = \frac{n π}{{2}^{{b}_{ϕ} - 1}} + \frac{π}{{2}^{{b}_{ϕ}}} , n = 1 , 2 , … , {2}^{{b}_{ϕ} - 1}$$

$${\hat{ψ}}_{i}^{( k )}$$

denotes quantized ψ corresponding to a i-th stream of a k-th subcarrier, and \hat{ϕ}ᵢ^{(k)} denotes quantized ϕ corresponding to a i-th stream of a k-th subcarrier.

According to an embodiment, a plurality of channel information to be pre-processed may include quantized angle information \hat{ψ}ᵢ^{(k)}, \hat{ϕ}ᵢ^{(k)} corresponding to a plurality of subcarriers.

According to an embodiment, the channel estimator 110 may generate delta-SNR information corresponding to the plurality of subcarriers based on a received NDP. According to some embodiments, the delta-SNR information may be generated by the beamforming feedback generator 120.

The delta-SNR information may be expressed as in [Equation 8] below.

$${Δ SNR}_{k , i} = min ( max ( 10 {log}_{10} ( \frac{{‖ {H}_{k} {V}_{k , i} ‖}^{2}}{{P}_{N , i}} ) - {\overline{SNR}}_{i} ) , - 8 ) , 7 ) \qquad [ Equation 8 ]$$

$${\overline{SNR}}_{i} = 10 {log}_{10} \{ \frac{{\vert HV \vert}^{2}}{{P}_{N}} \}$$

ΔSNR_{k,i} may denote to delta-SNR information, Hₖ may denote a channel estimate of a k-th subcarrier, V_{k,i} may denote a right singular matrix corresponding to a i-th stream of a k-th subcarrier, P_{N,i} may denote a reception power corresponding to i-th stream, and S̅N̅R̅ᵢ may denote an average SNR for i-th streams. Meanwhile, S̅N̅R̅ᵢ may be quantized to the 8-bit size, i.c., 8 bits, and the delta-SNR information ΔSNR_{k,i} may be quantized to the 4-bit size, i.e. 4 bits. Corresponding bit sizes may be promised between the beamformee 100 and the beamformer 30 by the current protocol standard.

According to an embodiment, a plurality of channel information to be pre-processed may include quantized delta-SNR information ΔSNR_{k,i} corresponding to a plurality of subcarriers.

However, since methods of generating quantized angle information \hat{ψ}ᵢ^{(k)}, \hat{ϕ}ᵢ^{(k)} and quantized delta-SNR information ΔSNR_{k,i} described above are merely embodiments, the inventive concept is not limited thereto, and the quantized angle information \hat{ψ}ᵢ^{(k)}, \hat{ϕ}ᵢ^{(k)} and the quantized delta-SNR information ΔSNR_{k,i} may be generated in various ways. Also, the plurality of channel information may further include various information.

According to an embodiment, the beamforming feedback generator 120 may include an encoding circuit 121. The encoding circuit 121 may perform pre-processing on a plurality of channel information and perform encoding on a plurality of pre-processed channel information. The encoding circuit 121 may pre-process a plurality of channel information based on a pre-processing function designed and configured to have a plurality of variable sections. Also, the encoding circuit 121 may generate binary information corresponding to a plurality of channel information used for post-processing of the decoding circuit 30_3 of the beamformer 30. According to some embodiments, the encoding circuit 121 may normalize a plurality of channel information prior to pre-processing. Thereafter, the encoding circuit 121 may encode a plurality of pre-processed channel information by using an autoencoder-based encoder. For example, a plurality of encoded channel information may include key features of a plurality of pre-processed channel information. Therefore, the data size of the plurality of encoded channel information may be smaller than the data size of the plurality of pre-processed channel information. The beamforming feedback generator 120 may generate beamforming feedback including a plurality of encoded channels. The beamforming feedback may further include the binary information described above. The beamformee 100 may transmit the beamforming feedback to the beamformer 30 through a transmitter of the beamformee 100 and the plurality of second antennas AT_12 to AT_Y2.

The beamformer 30 may receive beamforming feedback from the beamformee 100 through the plurality of first antennas AT_11 to AT_X1 and a transmitter. The controller 30_1 may control all operations for communication of the beamformer 30. The controller 30_1 may generate a Null Data Packet Announcement (NDPA) frame and an NDP, and the decoding circuit 30_3 may process information included in beamforming feedback, such that the information included in the beamforming feedback is usable by the beamforming circuit 30_2.

According to an embodiment, the decoding circuit 30_3 may perform decoding on a plurality of channel information extracted from beamforming feedback and perform post-processing on a plurality of decoded channel information. The decoding circuit 30_3 may decode a plurality of channel information by using an autoencoder-based decoder. Thereafter, the decoding circuit 30_3 may post-process a plurality of encoded channel information based on binary information extracted by a post-processing function and beamforming feedback. According to some embodiments, the encoding circuit 121 may denormalize a plurality of post-processed channel information. The beamforming circuit 30_2 may perform beamforming based on the plurality of post-processed channel information provided from the encoding circuit 121.

Further referring to FIG. 2B, an autoencoder may include an encoder and a decoder. The encoder is a cognitive network that may sequentially transform input data X11 to XN1 into first intermediate data X12 to XM2 and transform the first intermediate data X12 to XM2 into latent vectors LV1 to LVL. The decoder is a generative network that may convert the latent vectors LV1 to LVL into second intermediate data Y12 to YM2 and convert the second intermediate data Y12 to YM2 into output data Y11 to YN1. For example, the autoencoder has the same number of neurons in an input layer and an output layer, and the number of neurons in a hidden layer may be less than the number of neurons in the input layer or the output layer. The autoencoder may be generated through unsupervised learning to generate the latent vectors LV1 to LVL that represent important features of the input data X11 to XN1. In this specification, learning (or training) for an encoder or learning (or training) for a decoder may be understood as learning (or training) for an autoencoder.

An autoencoder applicable to embodiments may correspond to any one of an ‘Uncomplete’ autoencoder, a ‘Stacked’ autoencoder, a ‘Denoising’ autoencoder, a ‘Sparse’ autoencoder, a ‘Variational’ autoencoder, etc.

According to an embodiment, the input data X11 to XN1 input to the encoder may be pre-processed as described above, and the output data Y11 to YN1 output from the decoder may be post-processed as described above, and thus learning (or training) for the autoencoder may be performed.

Also, according to an embodiment, an encoder of a trained autoencoder may be implemented to be included in the encoding circuit 121 of the beamformee 100 in the form of hardware or software or a combination thereof, and a decoder of the trained autoencoder may be implemented to be included in the decoding circuit 30_3 of the beamformer 30 in the form of hardware or software or a combination thereof. Furthermore, the encoder of the encoding circuit 121 and the decoder of the decoding circuit 30_3 may be continuously trained.

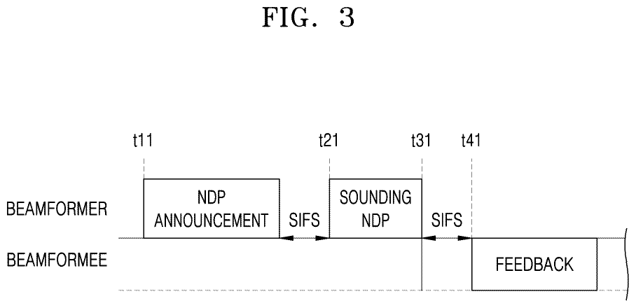

FIG. 3 is a timing diagram illustrating channel sounding according to an embodiment. In detail, the timing diagram of FIG. 3 represents channel sounding performed by a beamformer and a beamformee. The channel sounding may be based on various protocol standards. According to some embodiments, the beamformer may be an access point (or a second device) and the beamformee may be a station (or a first device). However, it should be noted that FIG. 3 is merely an embodiment, and that embodiments of the inventive concept are not limited to the channel sounding of FIG. 3.

Referring to FIG. 3, at a time point t11, the beamformer may transmit an NDPA frame to the beamformee. For example, the beamformer may transmit an NDPA frame to the beamformec notifying transmission of a sounding NDP to obtain channel state information of a downlink. The NDPA frame may be a control frame, and the beamformee may prepare to receive a sounding NDP based on the NDPA frame.

At a time point t21, the beamformer may transmit a sounding NDP (or an NDP) to the beamformec. For example, the beamformer may transmit a sounding NDP (or an NDP) to the beamformee a short interframe space (SIFS) time after transmitting an NDPA frame to the beamformec. The beamformer may transmit a sounding NDP to the beamformee via a plurality of subcarriers using a plurality of first antennas, and the beamformee may generate a plurality of channel information corresponding to the plurality of subcarriers based on a received sounding NDP. The beamformee may post-process the plurality of channel information based on a pre-processing function having plurality of variable sections and encode a plurality of post-processed channel information. The beamformee may generate beamforming feedback including encoded channel information, which channel information may include a plurality of channel information components.

At a time point t41, the beamformee may transmit the beamforming feedback to the beamformer. For example, the beamformee may transmit the beamforming feedback to the beamformer an SIFS time after the time point t31 at which the sounding NDP is received.

The beamformer may decode a plurality of channel information extracted from the beamforming feedback, post-process a plurality of decoded channel information, and transmit a PPDU to the beamformee based on a plurality of post-processed channel information.

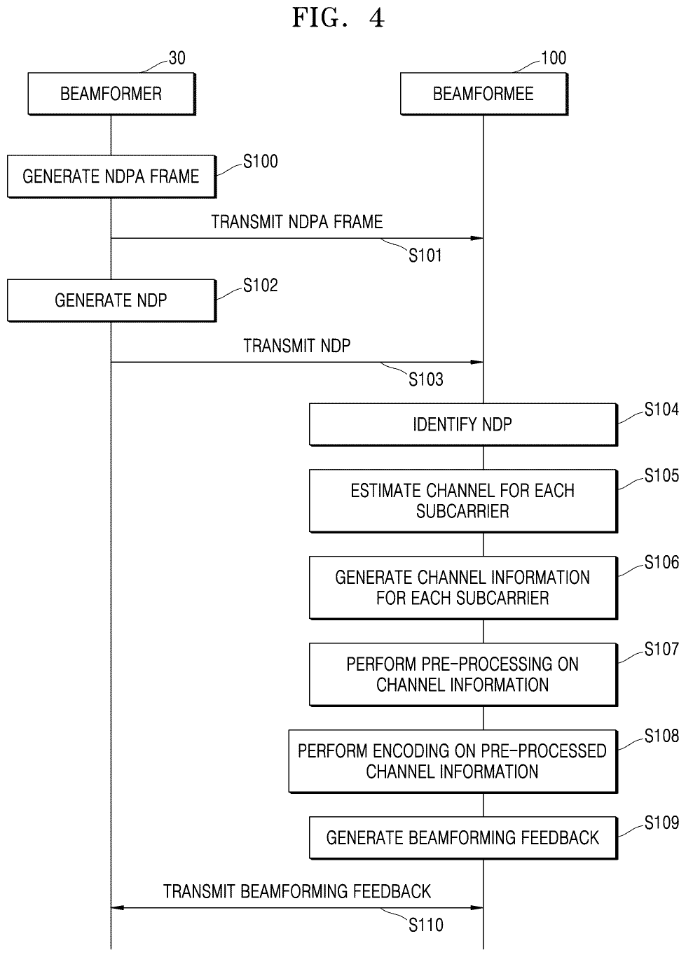

FIG. 4 is a message diagram illustrating a method for channel sounding according to an embodiment. In detail, the message diagram of FIG. 4 shows operations of the beamformer 30 as an access point and the beamformee 100 as one of a plurality of stations over time.

Referring to FIG. 4, in operation S100, the beamformer 30 may generate an NDPA frame. For example, the beamformer 30 may select one beamformee 100 to perform channel sounding from among associated beamformees, and generate an NDPA frame based on a selected beamformee 100. The NDPA frame may include a control frame, and the beamformee 100 may prepare to receive an NDP based on the NDPA frame.

In operation S101, the beamformer 30 may transmit the NDPA frame to the beamformee 100.

In operation S102, the beamformer 30 may generate an NDP corresponding to the beamformee 100.

In operation S103, the beamformer 30 may transmit the NDP to the beamformee 100.

In operation S104, the beamformee 100 may identify the NDP. For example, the beamformee 100 may target itself and extract information (or data) contained in fields of the NDP transmitted from the beamformer 30.

In operation S105, the beamformee 100 may perform channel estimation for each subcarrier by using information extracted from the fields of the NDP. For example, the beamformee 100 may estimate channels corresponding to subcarriers and perform singular value decomposition on estimated channels to generate beam steering matrices corresponding to the subcarriers. Also, according to an embodiment, the beamformee 100 may generate SNRs corresponding to the subcarriers.

In operation S106, the beamformee 100 may generate channel information for each subcarrier based on a result of operation S105. In other words, the beamformee 100 may generate a plurality of channel information corresponding to a plurality of subcarriers. For example, the plurality of channel information may include quantized angle information or quantized delta-SNR information.

In operation S107, the beamformee 100 may perform pre-processing on the channel information generated in operation S106. For example, the beamformee 100 may pre-process channel information by using a pre-processing circuit designed and configured to be suitable for the structure of an autoencoder-based encoder used in operation S108. According to an embodiment, the pre-processing function of the pre-processing circuit may have a plurality of variable sections and be defined as a different function for each variable section. The beamformee 100 may generate binary information indicating variable sections to which a plurality of channel information belong from among a plurality of variable sections.

In operation S108, the beamformee 100 may perform encoding on the channel information pre-processed in operation S107. For example, the beamformee 100 may encode pre-processed channel information by using an autoencoder-based encoder.

In operation S109, the beamformee 100 may generate beamforming feedback including the channel information encoded in operation S108. For example, the beamforming feedback may further include binary information corresponding to encoded channel information.

In operation S110, the beamformee 100 may transmit the beamforming feedback generated in operation S109 to the beamformer 30.

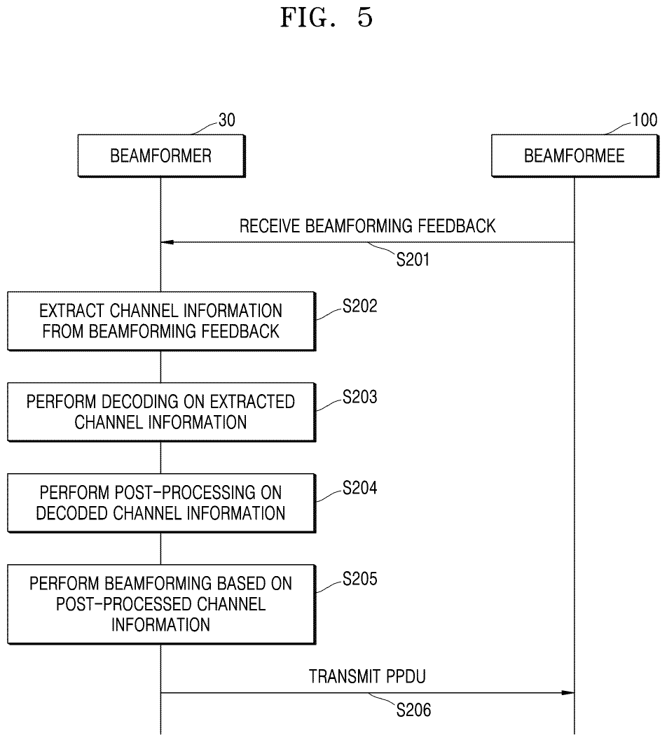

FIG. 5 is a message diagram illustrating a method for channel sounding according to an embodiment. In detail, the message diagram of FIG. 5 shows operations of the beamformer 30 as an access point and the beamformee 100 as one of a plurality of stations over time.

Referring to FIG. 5, in operation S201, the beamformer 30 may receive beamforming feedback from the beamformec 100.

In operation S202, the beamformer 30 may extract channel information from the beamforming feedback. For example, the beamformer 30 further extracts binary information corresponding to channel information from the beamforming feedback, and extracted binary information may be used in operation S204 described below.

In operation S203, the beamformer 30 may perform decoding on the channel information extracted in operation S202. For example, the beamformer 30 may decode extracted channel information by using an autoencoder-based decoder.

In operation S204, the beamformer 30 may perform post-processing on the channel information decoded in operation S203. For example, the beamformer 30 may post-process decoded channel information by using a post-processing circuit corresponding to the pre-processing circuit of the beamformee 100. For example, the post-processing function of the post-processing circuit may be the inverse function of the pre-processing function of the pre-processing circuit. The beamformer 30 may post-process decoded channel information based on binary information and a post-processing function.

In operation S205, the beamformer 30 may perform beamforming based on the channel information post-processed in operation S204.

In operation S206, the beamformer 30 may transmit a PPDU to the beamformee 100 based on the beamforming in operation S205.

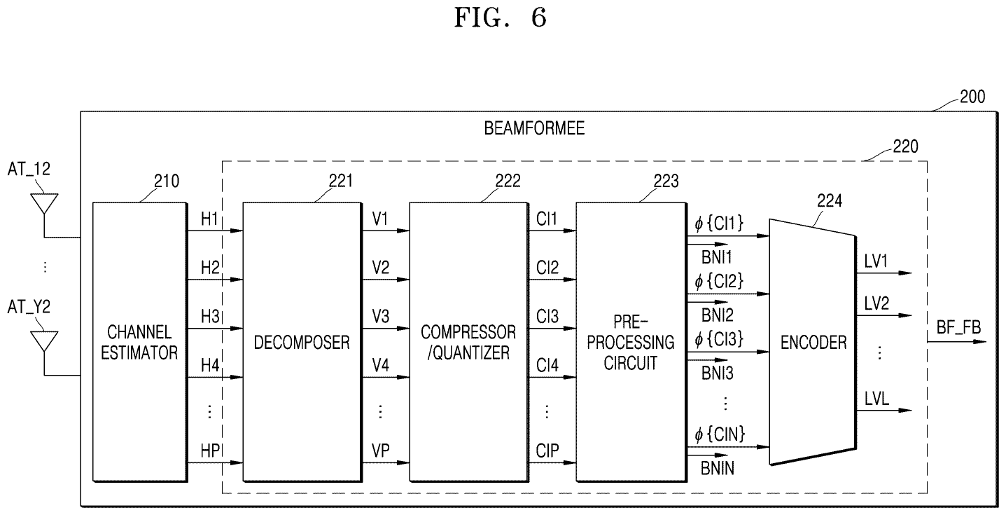

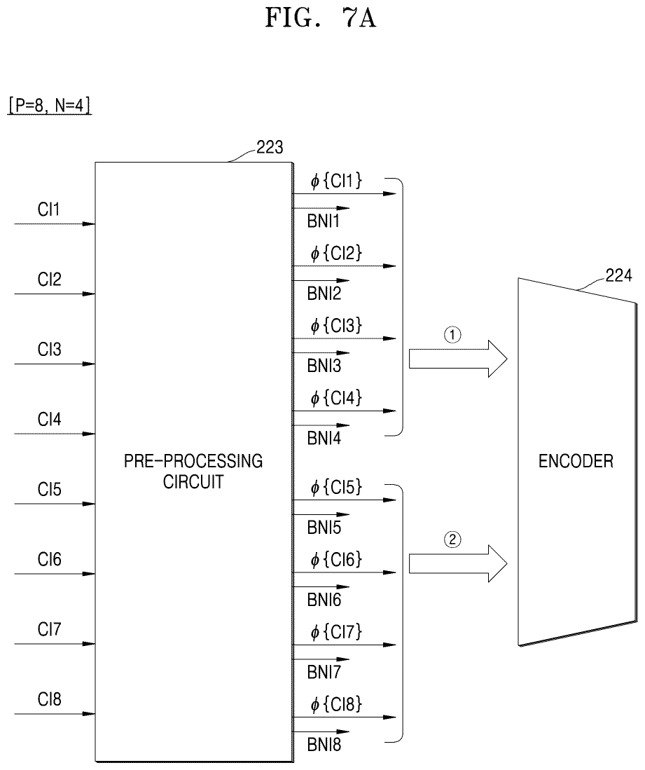

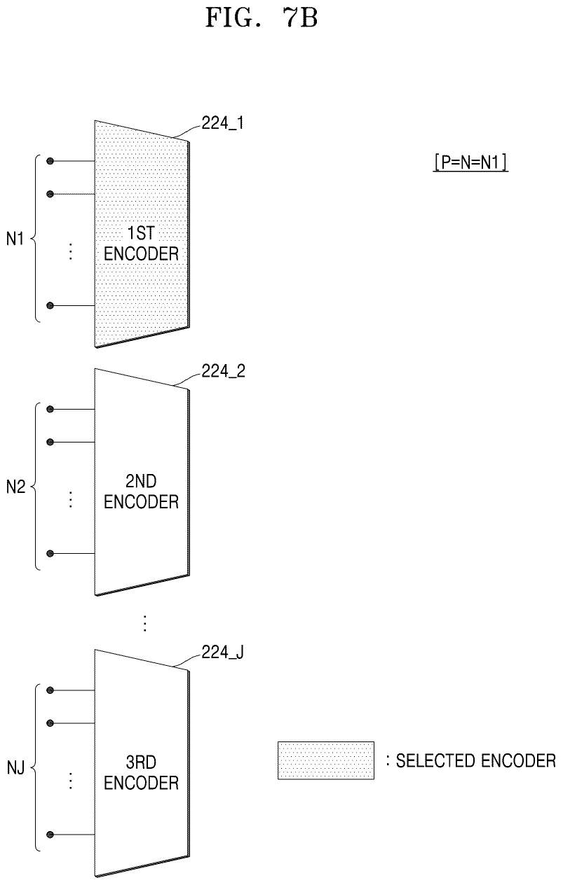

FIG. 6 is a detailed block diagram showing a beamformee 200 according to an embodiment, FIG. 7A is a diagram for describing an operation of a pre-processing circuit 223 of FIG. 6, and FIG. 7B is a diagram for describing an implementation example of an encoder 224 of FIG. 6.

It is assumed that a plurality of channel information pre-processed and encoded in FIG. 6 corresponds to a plurality of angle information, and the number of streams per subcarrier is one. However, it is merely for convenience of explanation, and it will be fully understood that the inventive concept is not limited thereto.

Referring to FIG. 6, the beamformee 200 may include the plurality of second antennas AT_12 to AT_Y2, a channel estimator 210, a decomposer 221, a compressor/quantizer 222, the pre-processing circuit 223, and the encoder 224. The decomposer 221, the compressor/quantizer 222, the pre-processing circuit 223, and the encoder 224 may constitute a beamforming feedback generator 220, and the pre-processing circuit 223 and the encoder 224 may constitute the encoding circuit 121 of FIG. 2A.

The channel estimator 210 may estimate first to P-th channels H1 to HP respectively corresponding to first to P-th subcarriers and provide the first to P-th channels H1 to HP to the decomposer 221. The decomposer 221 may generate first to P-th beam steering matrices V1 to VP respectively corresponding to the first to P-th subcarriers through singular value decomposition for the first to P-th channels H1 to HP and provide the first to P-th beam steering matrices V1 to VP to the compressor/quantizer 222. The compressor/quantizer 222 may generate first to P-th channel information CI1 to CIP based on the first to P-th beam steering matrices VI to VP and provide the first to P-th channel information CI1 to CIP to the pre-processing circuit 223.

According to an embodiment, the pre-processing circuit 223 may pre-process the first to P-th channel information CI1 to CIP based on a pre-processing function to generate pre-processed first to N-th channel information f(CI1) to f (CIN). Also, the pre-processing circuit 223 may generate first to N-th binary information BNI1 to BNIN indicating variable sections to which first to N-th channel information CI1 to CIN belong from among a plurality of variable sections of the pre-processing function. According to some embodiments, the pre-processing circuit 223 may perform pre-processing after normalizing the first to P-th channel information CI1 to CIP.

According to an embodiment, the pre-processing circuit 223 may be designed and configured based on an encoder. For example, the pre-processing circuit 223 may be designed to output numbers of pre-processed channel information and binary information corresponding to the number of pieces of data input to the encoder at one time. FIGS. 7A and 7B to explain an implementation example of the pre-processing circuit 223.

In FIG. 7A, it may be assumed that P is 8 and N is 4. Referring further to FIG. 7A, when the number of pieces of data input to the encoder 224 at one time is four, the pre-processing circuit 223 may output four pieces of pre-processed channel information and four pieces of binary information. In detail, the pre-processing circuit 223 may receive first to eighth channel information CI1 to CI8, pre-process first to fourth channel information CI1 to CI4 to output pre-processed first to fourth channel information f(CI1) to f(CI4) and first to fourth binary information BNI1 to BNI4, and, subsequently, pre-process fifth to eighth channel information CI5 to CI8 to output pre-processed fifth to eighth channel information f(CI5) to f(CI8) and fifth to eighth binary information BNI5 to BNI8. Therefore, the encoder 224 may receive the pre-processed first to fourth channel information f(CI1) to f(CI4) and subsequently receive the pre-processed fifth to eighth channel information f(CI5) to f(CI8).

Referring further to FIG. 7B, the beamforming feedback generator 220 of the beamformee 200 may include first to J-th encoders 224_1 to 224_J. The first to J-th encoders 224_1 to 224_J may be trained in different ways and have different numbers of inputs N1 to NJ.

For example, when a first encoder 224_1 is selected from among the first to J-th encoders 224_1 to 224_J, since both P and N are N1, the number of the first to P-th channel information CII to CIP input to the pre-processing circuit 223 at once may be equal to the number of the pre-processed first to N-th channel information f(CI1) to f(CIN) input to the encoder 224 at once.

Referring back to FIG. 6, the encoder 224 may encode the pre-processed first to N-th channel information f(CI1) to f(CIN) to generate first to L-th latent vectors LV1 to LVL.

According to an embodiment, the beamforming feedback generator 220 may generate beamforming feedback BF_FB including the first to L-th latent vectors LV1 to LVL and the first to N-th binary information BNI1 to BNIN.

According to some embodiments, the beamforming feedback generator 220 may further include a quantization circuit that performs quantization on the first to L-th latent vectors LV1 to LVL, and the beamforming feedback BF_FB may include quantized first to L-th latent vectors LV1 to LVL.

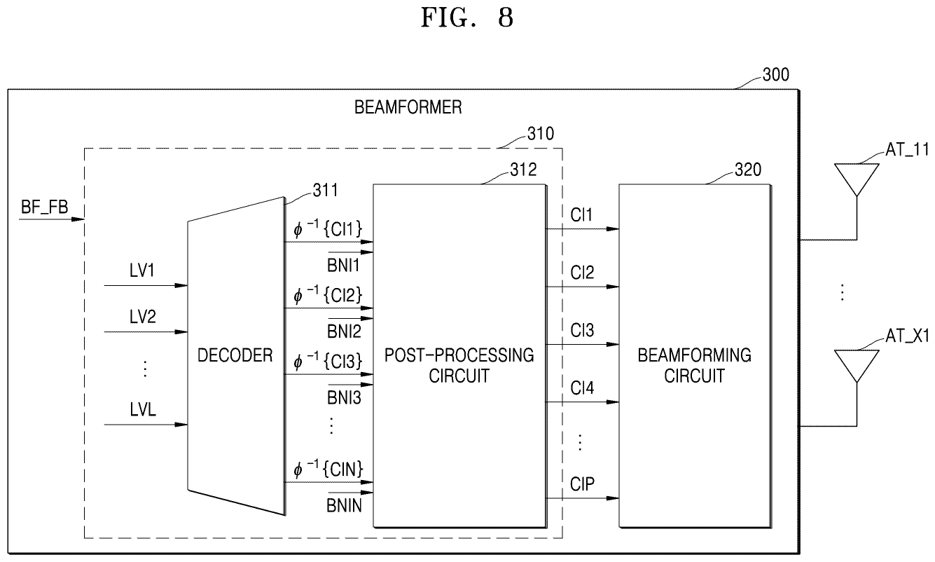

FIG. 8 is a detailed block diagram showing a beamformer 300 according to an embodiment.

Referring to FIG. 8, the beamformer 300 may include a decoder 311, a post-processing circuit 312, and a beamforming circuit 320. The decoder 311 and the post-processing circuit 312 may constitute a decoding circuit 310.

According to an embodiment, the decoder 311 may decode the first to L-th latent vectors LV1 to LVL included in the beamforming feedback BF_FB and provided decoded first to N-th channel information f⁻¹(C11) to f⁻¹(CIN) to the post-processing circuit 312.

According to an embodiment, the post-processing circuit 312 may post-process the first to N-th channel information f⁻¹(CI1) to f⁻¹(CIN) decoded based on the first to N-th binary information BNI1 to BNIN included in the beamforming feedback BF_FB and a post-processing function. According to some embodiments, the post-processing circuit 312 may perform denormalization after post-processing the decoded first to N-th channel information f⁻¹(CI1) to f⁻¹(CIN).

According to an embodiment, the decoding circuit 310 may generate post-processed first to P-th channel information CI1 to CIP using the decoder 311 and the post-processing circuit 312 and provide the post-processed first to P-th channel information CI1 to CIP to the beamforming circuit 320.

According to an embodiment, the beamforming circuit 320 may perform beamforming based on the post-processed first to P-th channel information CI1 to CIP.

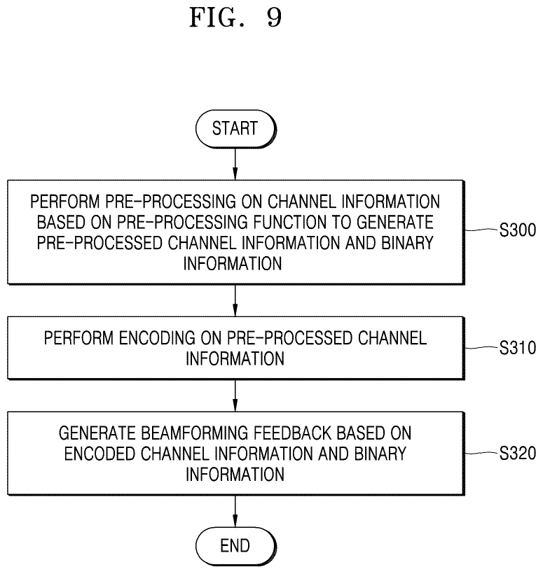

FIG. 9 is a flowchart for describing the operation of a beamformee according to an embodiment.

Referring to FIG. 9, in operation S300, the beamformee may perform pre-processing on channel information based on a pre-processing function to generate pre-processed channel information and pre-processed binary information.

In operation S310, the beamformee may perform encoding on the channel information pre-processed in operation S300. According to an embodiment, the beamformee may encode pre-processed channel information by using an autoencoder-based encoder.

In operation S320, the beamformee may generate beamforming feedback based on the channel information encoded in operation S310 and the binary information generated in operation S300.asdf

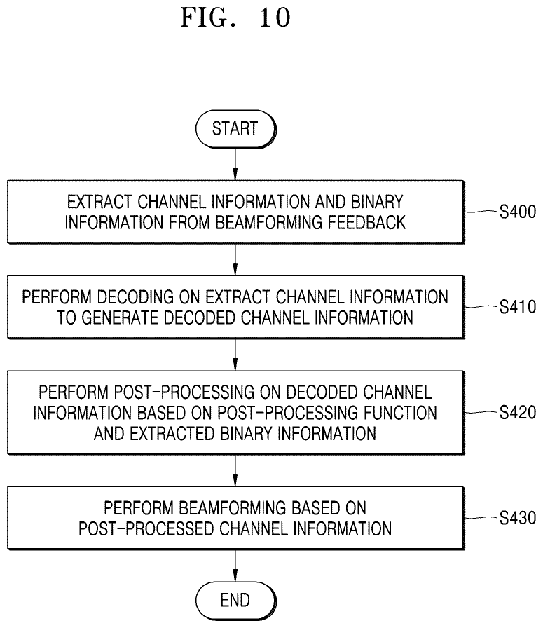

FIG. 10 is a flowchart for describing the operation of a beamformer according to an embodiment.

Referring to FIG. 10, in operation S400, the beamformer may extract channel information and binary information from beamforming feedback.

In operation S410, the beamformer may decode the channel information extracted in operation S400 to generate decoded channel information.

In operation S420, the beamformer may perform post-processing on the channel information decoded in operation S410 based on a post-processing function and the binary information extracted in operation S400.

In operation S430, the beamformer may perform beamforming based on the channel information post-processed in operation S420.

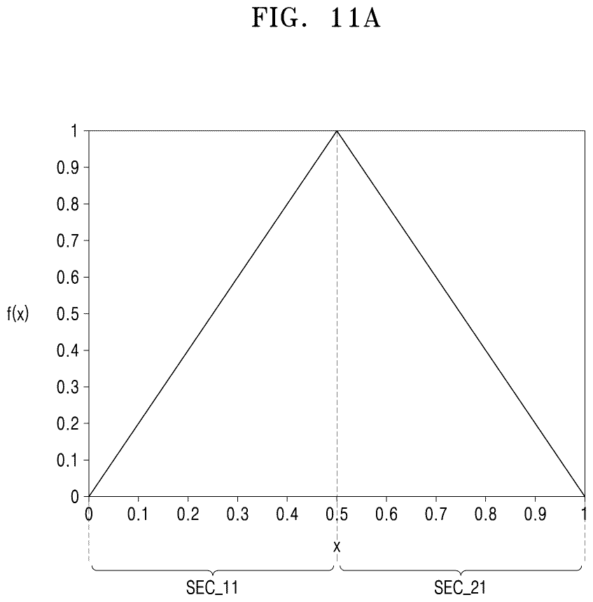

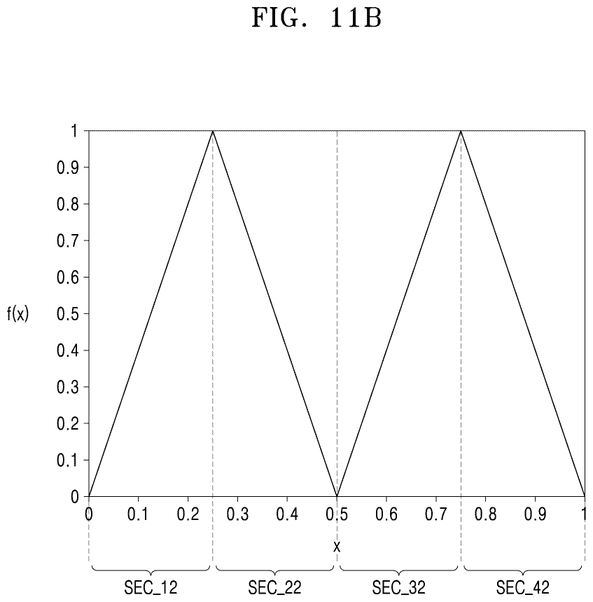

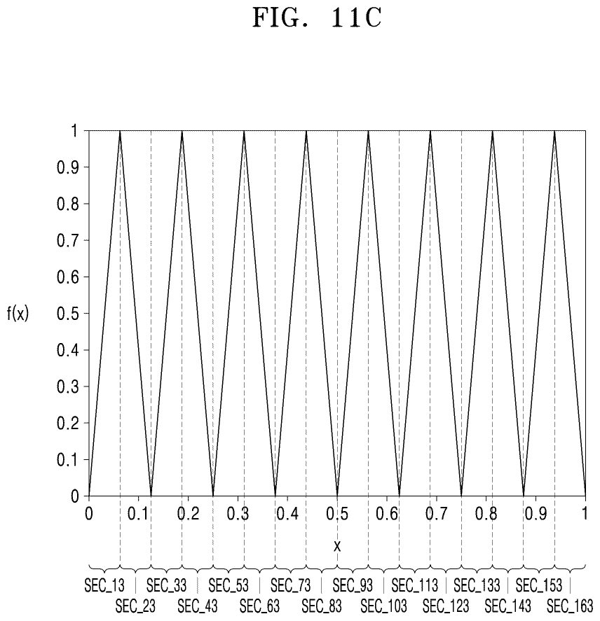

FIGS. 11A to 11C are diagrams illustrating a pre-processing function f(x), which is the basis for a pre-processing operation according to an embodiment. Meanwhile, it is assumed that data input to a pre-processing function f(x) is normalized to a value between 0 and 1.

Referring to FIG. 11A, a pre-processing function f(x) may be defined as in [Equation 9] below.

$$f ( x ) = \frac{{x}_{max}}{2} - \vert x - \frac{{x}_{max}}{2} \vert = \{ \begin{matrix}x & for 0 \leq x < \frac{{x}_{max}}{2} \\ - x + {x}_{max} & for \frac{{x}_{max}}{2} \leq x \leq {x}_{max}\end{matrix} \qquad [ Equation 9 ]$$

xₘₐₓ is the normalized maximum input value, which may correspond to 1, a first variable section SEC_11 may correspond to

$$0 \leq x < \frac{{x}_{max}}{2} ,$$

and a second variable section SEC_21 may correspond to

$$\frac{{x}_{max}}{2} \leq x \leq {x}_{max} .$$

The pre-processing function f(x) may be defined as f(x)=x in the first variable section SEC_11 and defined as f(x)=−x+xₘₐₓ in the second variable section SEC_21. In this way, the pre-processing function f(x) may have two variable sections, that is, the first variable section SEC_11 and the second variable section SEC_21. Also, the binary information indicating a variable section to which data input to the pre-processing function f(x) may include one bit.

The post-processing function f⁻¹(x) may be defined as in [Equation 10] below.

$${f}^{- 1} ( x ) = \{ \begin{matrix}x & for 0 \leq x < \frac{{x}_{max}}{2} \\ - x + {x}_{max} & for \frac{{x}_{max}}{2} \leq x \leq {x}_{max}\end{matrix} \qquad [ Equation 10 ]$$

For example, when the value of channel information input to the pre-processing function f(x) is 0.4, the value of pre-processed channel information may be 0.4. Also, the value of binary information corresponding to the channel information may be 0, indicating that the value belongs to the first variable section SEC_11. The post-processing function f⁻¹(x) is determined as f⁻¹(x)=x based on the binary information having the value of 0 in the post-processing function f⁻¹(x), and channel information having the value of 0.4 with respect to determined post-processing function f⁻¹(x) may be post-processed to have the value of 0.4.

Referring to FIG. 11B, a pre-processing function f(x) may be defined as in [Equation 11] below.

$$[ Equation 11 ]$$

$$f ( x ) = \frac{{x}_{max}}{4} \vert 1 - \vert 1 - 2 \vert \frac{x}{{x}_{max} {/}_{2}} - 1 \vert \vert \vert = \{ \begin{matrix}x for 0 \leq x \leq \frac{{x}_{max}}{4} \\ - x + \frac{{x}_{max}}{2} for \frac{{x}_{max}}{4} \leq x < \frac{{x}_{max}}{2} \\ x - \frac{{x}_{max}}{2} for \frac{{x}_{max}}{2} \leq x < \frac{3 {x}_{max}}{4} \\ - x + {x}_{max} for \frac{3 {x}_{max}}{4} \leq x \leq {x}_{max}\end{matrix}$$

xₘₐₓ is the normalized maximum input value, which may correspond to 1, a first variable section SEC_12 may correspond to

$$0 \leq x < \frac{{x}_{max}}{4} ,$$

a second variable section SEC_22 may correspond to

$$\frac{{x}_{max}}{4} \leq x < \frac{{x}_{max}}{2} ,$$

a third variable section SEC_32 may correspond to

$$\frac{{x}_{max}}{2} \leq x < \frac{3 {x}_{max}}{4} ,$$

and a fourth variable section SEC_42 may correspond to

$$\frac{3 {x}_{max}}{4} \leq x \leq {x}_{max} .$$

The pre-processing function f(x) may be defined as f(x)=x in the first variable section SEC_12, defined as

$$f ( x ) = - x + \frac{{x}_{max}}{2}$$

in the second variable section SEC_22, defined as

$$f ( x ) = x - \frac{{x}_{max}}{2}$$

in the third variable section SEC_32, and defined as f(x)=−x+xₘₐₓ in the fourth variable section SEC_42. In this way, the pre-processing function f(x) may have four variable sections, that is, the first variable section SEC_12 to the fourth variable section SEC_42. Also, the binary information indicating a variable section to which data input to the pre-processing function f(x) may include two bits.

The post-processing function f⁻¹(x) may be defined as in [Equation 12] below.

$${f}^{- 1} ( x ) = \{ \begin{matrix}x for 0 \leq x \leq \frac{{x}_{max}}{4} \\ - x - \frac{{x}_{max}}{2} for \frac{{x}_{max}}{4} \leq x < \frac{{x}_{max}}{2} \\ x + \frac{{x}_{max}}{2} for \frac{{x}_{max}}{2} \leq x < \frac{3 {x}_{max}}{4} \\ - x - {x}_{max} for \frac{3 {x}_{max}}{4} \leq x \leq {x}_{max}\end{matrix}$$

Referring to FIG. 11C, a pre-processing function f(x) may be defined as in [Equation 13] below.

$$f ( x ) = \frac{{x}_{max}}{16} \vert 1 - \vert 1 - 2 \vert 1 - 2 \vert 1 - 2 \vert \frac{x}{{x}_{max / 2}} - 1 \vert \vert \vert \vert \vert \qquad [ Equation 13 ]$$

xₘₐₓ is the normalized maximum input value, which may be 1, and the pre-processing function f(x) may have 16 variable sections SEC_13 to SEC_163. Since the pre-processing function f(x) has been sufficiently described with reference to FIGS. 11A and 11B, detailed descriptions thereof will be omitted. The binary information indicating a variable section to which data input to the pre-processing function f(x) may include four bits.

The post-processing function f⁻¹(x) may be defined as in [Equation 14] below.

$${f}^{- 1} ( x ) = \qquad [ Equation 14 ]$$

Meanwhile, as shown in FIGS. 11A to 11C, the pre-processing function f(x) is an one-on-one correspondence function, is a continuous function, and a first function output according to the minimum input having the value of 0 and a second function output according to the maximum input having the value of 1 may be identical to each other, that is, 0.

According to an embodiment, the pre-processing function f(x) may be generalized as in [Equation 15] below.

$$[ Equation 15 ]$$

$$f ( x ) = \frac{{2}^{M}}{{2}^{R}} \vert 1 - {g}^{R} ( \frac{x}{{2}^{M}} ) \vert , where {g}^{R} ( x ) = {\underbrace{g ∘ g ∘ g … g ∘ g}}_{R terms}$$

$$g ( x ) = \vert 1 - 2 x \vert$$

M may denote the bit size for quantization of channel information to be pre-processed, and R may denote the number of a plurality of variable sections of the pre-processing function f(x) or the number of bits constituting binary information. For example, when the channel information is angle information, the bit size may comply with [Table 1], and, when the channel information is delta-SNR information, the bit size may be determined in advance.

For example, since the pre-processing function f(x) may vary according to a change of the value of at least one of R and M, a beamformee and a beamformer may signal information regarding the pre-processing function f(x), the beamformee may determine the pre-processing function f(x), and the beamformer may determine a post-processing function suitable for a determined pre-processing function f(x).

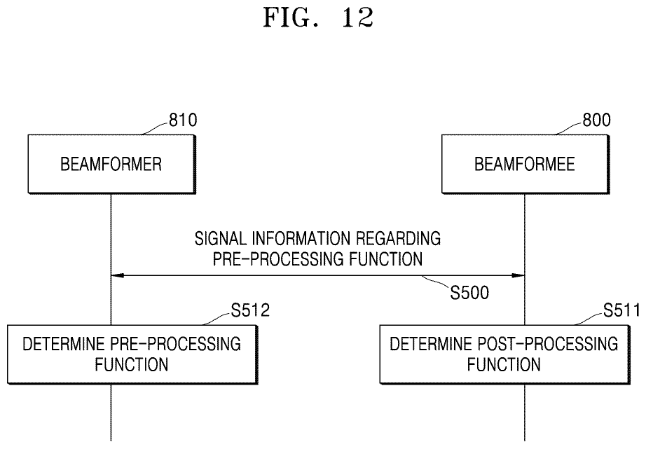

FIG. 12 is a message diagram illustrating a method of determining a pre-processing function or a post-processing function, according to an embodiment.

Referring to FIG. 12, in operation S500, a beamformee 800 and a beamformer 810 may signal information regarding a pre-processing function. For example, the beamformer 810 may transmit first information indicating a codebook size for quantization of a plurality of channel information (e.g., a plurality of angle information) to the beamformee 800. Also, the beamformee 800 may transmit second information indicating the number of a plurality of variable sections of a pre-processing function or the number of bits constituting binary information to the beamformer 810. The first information may be associated with M in [Equation 15], and the second information may be associated with R of [Equation 15].

In operation S511, the beamformee 800 may determine a pre-processing function based on information regarding a pre-processing function. The information regarding the pre-processing function may include the first information and the second information described above.

In operation S512, the beamformer 810 may determine a post-processing function based on information regarding the pre-processing function. For example, the beamformer 810 may recognize a currently determined pre-processing function based on the information regarding the pre-processing function and determine a post-processing function corresponding to the pre-processing function.

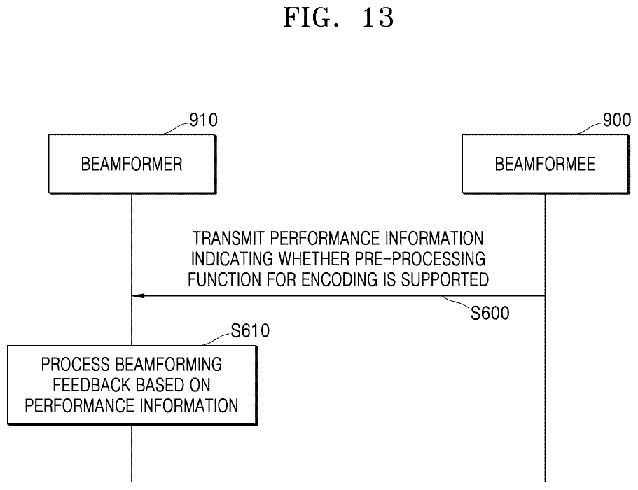

FIG. 13 is a message diagram illustrating a method of processing beamforming feedback, according to an embodiment.

Referring to FIG. 13, in operation S600, a beamformee 900 may transmit performance information indicating whether the beamformee 900 supports a pre-processing function for encoding to a beamformer 910. For example, the beamformee 900 may provide performance information indicating that the beamformee 900 is capable of performing pre-processing suitable for autoencoder-based encoding according to the inventive concept to the beamformer 910.

In operation S610, the beamformer 910 may process a beamforming feedback based on the performance information received from the beamformee 900 in operation S900. In other words, when the beamformer 910 supports the pre-processing function, the beamformee 900 may adaptively perform a post-processing operation when processing a beamforming feedback.

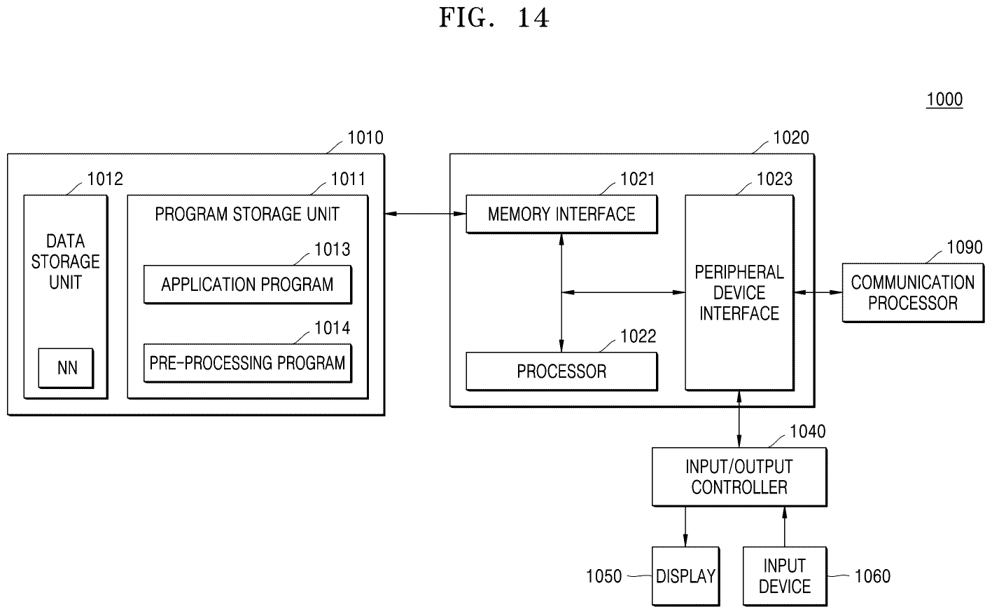

FIG. 14 is a block diagram showing an electronic device 1000 according to an embodiment. The electronic device 1000 of FIG. 14 may correspond to a beamformer.

Referring to FIG. 14, the electronic device 1000 may include a memory 1010, a processor unit 1020, an input/output controller 1040, a display 1050, an input device 1060, and a communication processor 1090. Selectively, a plurality of memories 1010 may be provided. Each components will be described below.

The memory 1010 may include a program storage unit 1011 that stores a program for controlling the operation of the electronic device 1000 and a data storage unit 1012 that stores data generated during the execution of a program. The data storage unit 1012 may store data needed for the operation of an application program 1013 and a pre-processing program 1014. According to an embodiment, the data storage unit 1012 may store a neural network model NN (an or encoder) trained based on an autoencoder according to embodiments.

The program storage unit 1011 may include the application program 1013 and the pre-processing program 1014. Here, a program included in the program storage unit 1011 is a collection of instructions and may be expressed as an instruction set. The application program 1013 may include program codes for executing various applications operating on the electronic device 1000. In other words, the application program 1013 may include codes (or commands) regarding various applications driven by a processor 1022. The pre-processing program 1014 may include control codes for performing pre-processing operations according to embodiments.

According to an embodiment, the processor 1022 may perform pre-processing on a plurality of channel information based on a pre-processing function by executing the pre-processing program 1014. A plurality of pre-processed channel information may be encoded by a neural network model NN, included in a beamforming feedback, and provided to another electronic device (e.g., a beamformer).

Meanwhile, the electronic device 1000 may include the communication processor 1090 that performs communication functions for voice communication and data communication. The processor 1022 may transmit a beamforming feedback to another electronic device via the communication processor 1090.

A peripheral device interface 1023 may control connections between the input/output controller 1040, the communication processor 1090, the processor 1022, and a memory interface 1021. The input/output controller 1040 may provide an interface between an input/output device, such as the display 1050 and the input device 1060, and the peripheral device interface 1023. The display 1050 displays status information, input characters, moving pictures, and still pictures. For example, the display 1050 may display information regarding an application program driven by the processor 1022.

The input device 1060 may provide input data generated by selection of the electronic device 1000 to the processor unit 1020 through the input/output controller 1040. At this time, the input device 1060 may include a keypad including at least one hardware button and a touchpad that detects touch information. For example, the input device 1060 may provide touch information, such as touch, touch movement, and touch release detected through the touch pad, to the processor 1022 through the input/output controller 1040.

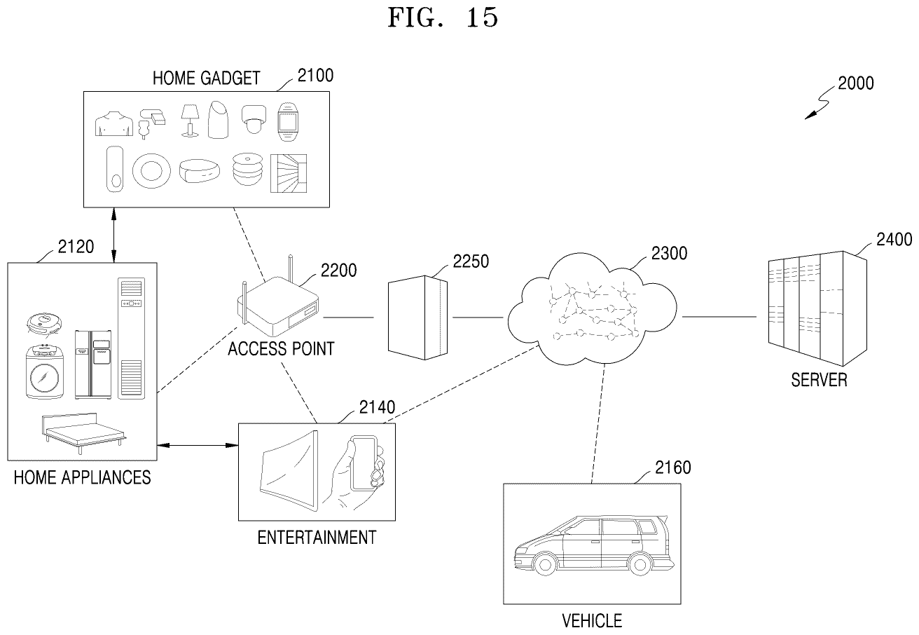

FIG. 15 is a conceptual diagram showing an Internet of Things (IoT) network system 2000 to which embodiments are applied.

Referring to FIG. 15, the IoT network system 2000 may include a plurality of IoT devices 2100, 2120, 2140, and 2160, an access point 2200, a gateway 2250, a wireless network 2300, and a server 2400. IoT may refer to a network of objects using wired/wireless communication.

The IoT devices 2100, 2120, 2140, and 2160 may form groups according to the characteristics of each IoT device. For example, the IoT devices 2100, 2120, 2140, and 2160 may be grouped into a home gadget group 2100, an appliance/furniture group 2120, an entertainment group 2140, or a vehicle group 2160. A plurality of IoT devices 2100, 2120, and 2140 may be connected to a communication network or other IoT devices through the access point 2200. The access point 2200 may be built into one IoT device. The gateway 2250 may change the protocol to allow the access point 2200 to connect to an external wireless network. The IoT devices 2100, 2120, and 2140 may be connected to an external communication network through the gateway 2250. The wireless network 2300 may include the Internet and/or a public network. The plurality of IoT devices 2100, 2120, 2140, and 2160 may be connected to the server 2400 providing a certain service through the wireless network 2300, and a user may use the service through at least one of the plurality of IoT devices 2100, 2120, 2140, and 2160.

According to embodiments of the inventive concept, the plurality of IoT devices 2100, 2120, 2140, and 2160 may perform a pre-processing operation suitable for an autoencoder-based encoder to efficiently operate a beamforming process while improving the performance of the beamforming process. As a result, the IoT devices 2100, 2120, 2140, and 2160) may perform efficient and effective communication to provide high quality services to users.

While the inventive concept has been particularly shown and described with reference to embodiments thereof, it will be understood that various changes in form and details may be made therein without departing from the spirit and scope of the following claims.

What is claimed is:

1. An operating method of a first device that communicates with a second device in a wireless local area network (WLAN) system including the first device and the second device, the operating method comprising:
receiving a null data packet (NDP) from the second device;
generating a plurality of channel information corresponding to a plurality of respective subcarriers by using the NDP;
performing pre-processing on the plurality of channel information based on a pre-processing function designed to have a plurality of variable sections to result in a plurality of pre-processed channel information;
performing encoding on the plurality of pre-processed channel information to result in a plurality of encoded channel information; and
transmitting beamforming feedback comprising the plurality of encoded channel information to the second device.

2. The operating method of claim 1, wherein the pre-processing function is designed to match characteristics of the plurality of channel information.

3. The operating method of claim 1, wherein the pre-processing function is a one-on-one correspondence function, is a continuous function, and is designed to satisfy a condition that a difference between a first function output according to a minimum input and a second function output according to a maximum input is less than a threshold value.

4. The operating method of claim 1, wherein:
in the performing of the pre-processing, a pre-processing circuit is used,
in the performing of the encoding, an encoder is used, and
the pre-processing circuit is designed based on the encoder.

5. The operating method of claim 1, wherein:
in the performing of the pre-processing, a pre-processing circuit is used, and
in the performing of the encoding, an encoder having a number of inputs matching a number of outputs of the pre-processing circuit is selected from among a plurality of encoders and used.

6. The operating method of claim 1, wherein:
the performing of the encoding further comprises generating a plurality of binary information corresponding to the plurality of channel information based on the pre-processing function, and
the beamforming feedback further comprises the plurality of binary information.

7. The operating method of claim 6, wherein:
the plurality of channel information comprise first channel information,
the plurality of binary information comprise first binary information corresponding to the first channel information, and
the generating of the plurality of binary information comprises generating the first binary information indicating a variable section to which the first channel information belongs from among the plurality of variable sections of the pre-processing function.

8. The operating method of claim 6, wherein the plurality of binary information are used by the second device for post-processing the plurality of encoded channel information after decoding.

9. The operating method of claim 1, wherein the generating of the plurality of channel information comprises:
generating a plurality of angle information corresponding to a plurality of respective subcarriers based on beam steering matrices corresponding to the plurality of subcarriers; and
quantizing the plurality of angle information into a bit size corresponding to a codebook size, wherein:
the plurality of channel information comprise a plurality of quantized angle information.

10. The operating method of claim 1, wherein the generating of the plurality of channel information comprises:
generating a plurality of delta-signal to noise ratio (SNR) information corresponding to a plurality of subcarriers based on SNRs corresponding to the plurality of subcarriers; and
quantizing the plurality of delta-SNR information into a certain bit size, wherein:
the plurality of channel information comprise a plurality of quantized delta-SNR information.

11. The operating method of claim 1, further comprising:
signaling information regarding the pre-processing function with the second device; and
determining the pre-processing function based on the information regarding the pre-processing function.

12. The operating method of claim 11, wherein the signaling of the information regarding the pre-processing function comprises:
receiving first information indicating a codebook size for quantization of the plurality of channel information from the second device; and
transmitting second information indicating a number of the plurality of variable sections to the second device, wherein:
the information regarding the pre-processing function comprises the first information and the second information.

13. The operating method of claim 1, further comprising transmitting to the second device performance information indicating whether the second device supports a pre-processing function for encoding.

14. An operating method of a second device that communicates with a first device in a wireless local area network (WLAN) system including the first device and the second device, the operating method comprising:
receiving a beamforming feedback from the first device;
extracting a plurality of channel information corresponding to a plurality of subcarriers from the beamforming feedback;
performing decoding on a plurality of extracted channel information;
performing post-processing on a plurality of decoded channel information based on a post-processing function, which is an inverse function of a pre-processing function designed to have a plurality of variable sections used for pre-processing of the first device; and
performing beamforming based on a plurality of post-processed channel information.

15. The operating method of claim 14, further comprising transmitting a physical protocol data unit (PPDU) to the first device based on the beamforming.

16. The operating method of claim 14, wherein:
the plurality of channel information comprise first channel information,
the extracting of the plurality of channel information comprises extracting first binary information indicating a variable section corresponding to the first channel information from among the plurality of variable sections from the beamforming feedback, and
the performing of the post-processing comprises post-processing first channel information decoded based on the first binary information and the post-processing function.

17. A first device configured to communicate with a second device in a wireless local area network (WLAN) system, the first device comprising:
a channel estimator configured to estimate channels corresponding to a plurality of subcarriers by using a null data packet (NDP) received from the second device; and
a beamforming feedback generator configured to generate a plurality of channel information corresponding to a plurality of subcarriers based on estimated channels, perform pre-processing on the plurality of channel information based on a pre-processing function designed to have a plurality of variable sections, perform encoding on a plurality of pre-processed channel information, and generate a beamforming feedback comprising a plurality of encoded channel information.

18. The first device of claim 17, wherein the pre-processing function is a one-on-one correspondence function, is a continuous function, and is designed to satisfy a condition that a difference between a first function output according to a minimum input and a second function output according to a maximum input is less than a threshold value.

19. The first device of claim 17, wherein:
the beamforming feedback generator further comprises an encoder used for encoding the plurality of pre-processed channel information, and
the encoder is trained based on an autoencoder.

20. The first device of claim 17, wherein the beamforming feedback further comprises a plurality of binary information indicating variable sections to which the plurality of channel information belong from among the plurality of variable sections.
